(19) United States
(12) Patent Application Publication
(10) Pub. No.: US 2021/0318579 A1
(43) Pub. Date: Oct. 14, 2021

(54) LIQUID CRYSTAL DISPLAY PANEL, DISPLAY MODULE, AND ELECTRONIC DEVICE

(71) Applicant: TCL CHINA STAR OPTOELECTRONICS TECHNOLOGY CO., LTD., Shenzhen, Guangdong (CN)

(72) Inventor: Yani CHEN, Shenzhen, Guangdong (CN)

(21) Appl. No.: 16/762,933

(22) PCT Filed: Apr. 21, 2020
(86) PCT No.: PCT/CN2020/085790

§ 371 Date: May 10, 2020

(30) Foreign Application Priority Data
Apr. 8, 2020 (CN) 202010270316.8

(51) Int. Cl. G02F 1/1343; G02F 1/1368; G02F 1/1362

(52) U.S. Cl. CPC G02F 1/134309; G02F 1/1368; G02F 2001/134354; G02F 1/13624; G02F 1/136286

(57) ABSTRACT

The present invention provides a liquid crystal display (LCD) panel, a display module, and an electronic device. The LCD panel includes predetermined electrodes connected to power supply voltages. A sub-display region includes at least one pixel column and is arranged corresponding to at least one of the predetermined electrode. The power supply voltages connected to the predetermined electrodes in the same sub-display region are equal. The power supply voltage in the sub-display region located in the middle of the LCD panel is different from the power supply voltages in the sub-display regions located on two sides of the LCD panel.

### FIELD OF DISCLOSURE

The present invention relates to a filed of display technology and in particular, to a liquid crystal display panel, a display module, and an electronic device.

### DESCRIPTION OF RELATED ART

For vertical alignment (VA) liquid crystal display (LCD) panels, liquid crystal molecules have large differences in birefringence at different viewing angles, a large color shift is likely to occur.

At present, 8-domain display technology is usually used to improve the viewing angles, that is, one pixel includes a main pixel region and a sub-pixel region, the pixel electrodes of the main pixel region and the sub-pixel region both have a double-cross shape (similar to a union jack pattern), and each pixel region has four display domains. By adding a transistor in the sub-pixel region, part of a voltage of the sub-pixel region is released to a predetermined electrode (sharebar), so that the voltages of the two pixel regions are different, thereby generating a difference in rotation angles of the liquid crystal molecules, and improving the viewing angles.

However, at present, voltages input to all the predetermined electrodes are the same. Consequently, when a size of the display panel is increased, the viewing angle cannot be effectively improved.

Therefore, it is necessary to provide a liquid crystal display panel, a display module and an electronic device to solve the problems in conventional techniques.

### SUMMARY

It is an objective of the present invention to provide a liquid crystal display (LCD) panel, a display module, and an electronic device, which can effectively improve viewing angles of a large-size display panel and avoid a color shift.

Accordingly, the present invention provides a liquid crystal display (LCD) panel comprising a display region, the LCD panel comprising:
a plurality of pixels arranged in an array, wherein the pixels are arranged in a plurality of columns of the array, each of the pixels comprises a main pixel region and a sub-pixel region, a brightness of the sub-pixel region is less than a brightness of the main pixel region, and the main pixel region is connected to a corresponding data line and a corresponding scan line;
a plurality of predetermined electrodes, wherein each of the predetermined electrodes is connected to a power supply voltage, the sub-pixel region is connected to the corresponding data line, the corresponding scan line, and one of the predetermined electrodes corresponding to the pixel for sharing electric charges in the sub-pixel region; and
a plurality of sub-display regions, wherein each of the sub-display regions comprises at least one pixel column and arranged corresponding to at least one of the predetermined electrodes, the power supply voltages connected to the predetermined electrodes in a same one of the sub-display regions are equal, and the power supply voltage in the sub-display region located in a middle of the LCD panel is different from the power supply voltages in the sub-display regions located on two sides of the LCD panel.

The present invention further provides a display module comprising the above-mentioned liquid crystal display (LCD) panel.

The present invention further provides an electronic device comprising the above-mentioned display module.

Since the power supply voltage in the sub-display region located in the middle of the LCD panel is different from the power supply voltages in the sub-display regions on two sides of the LCD panel, so that rotation angles of the liquid crystals are unequal, and viewing angles is effectively improved.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without inventive work.

FIG. 1 is an equivalent circuit diagram of a pixel in a conventional liquid crystal display (LCD) panel.

FIG. 2 is a top view illustrating an LCD panel according to one embodiment of the present invention.

FIG. 3 is an equivalent circuit diagram of a pixel in the LCD panel according to one embodiment of the present invention.

FIG. 4 is a top view illustrating the LCD panel according to another embodiment of the present invention.

### DETAILED DESCRIPTION OF EMBODIMENTS

A description is provided below with reference to specific embodiments of the present invention and in conjunction of the accompanying drawings. Directional terms described by the present invention, such as “upper”, “lower”, “front”, “rear”, “left”, “right”, “inner”, “outer”, and “lateral”, are only for illustrative purposes based on the accompanying drawings, and thus the directional terms are used to describe and understand the present invention, but are not intended to limit the present invention. In the drawings, structurally similar elements are denoted by the same reference numerals.

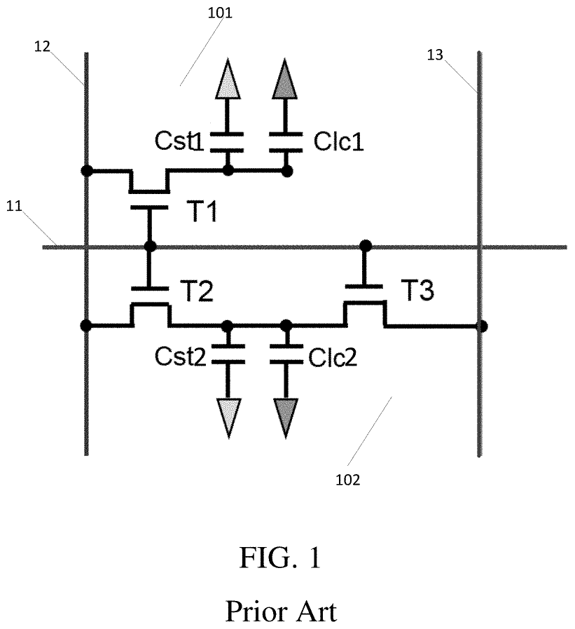

From a top view, a conventional display panel comprises multiple pixels, multiple scan lines, multiple data lines, and multiple predetermined electrodes. A cross-sectional structure of the display panel includes an array substrate, a color filter substrate, and a liquid crystal layer between the array substrate and the color filter substrate. As shown in FIG. 1, each of the pixels comprises a main pixel region 101 and a sub-pixel region 102. The main pixel region 101 includes a first transistor T1 whose gate is connected to a corresponding scan line 11. A source of the first transistor T1 is connected to a corresponding data line 12, and a drain is connected to a first electrode plate of a first liquid crystal capacitor Clc1 and a first electrode plate of a first storage capacitor Cst1. The first liquid crystal capacitor Clc1 is formed between the pixel electrode in the main pixel region 101 and a first common electrode, and the first storage capacitor Cst1 is formed between the pixel electrode in the main pixel region 101 and a second common electrode.

The sub-pixel region 102 comprises a second transistor T2 and a third transistor T3. A gate of the second transistor T2 is connected to the corresponding scan line 11, and a source of the second transistor T2 is connected to the corresponding data line 12. A gate of the third transistor T3 is connected to the corresponding scan line 11, a drain of the third transistor T3 is connected to a predetermined electrode 13, and a source of the third transistor T3 is connected to a drain of the second transistor T2. The drain of the second transistor T2 is connected to a first electrode plate of a second liquid crystal capacitor Clc2 and a first electrode plate of a second storage capacitor Cst2. The second liquid crystal capacitor Clc2 is formed between the pixel electrode in the sub-pixel region 102 and the first common electrode, and the second storage capacitor Cst2 is formed between the pixel electrode in the sub-pixel region 102 and the second common electrode. The first common electrode is a common electrode on a side of the array substrate, and the second electrode may be a common electrode on a side of the color filter substrate.

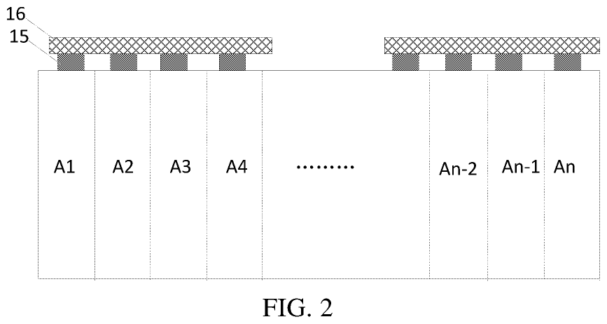

Please refer to FIGS. 2 to 4. FIG. 2 is a top view illustrating an LCD panel according to one embodiment of the present invention.

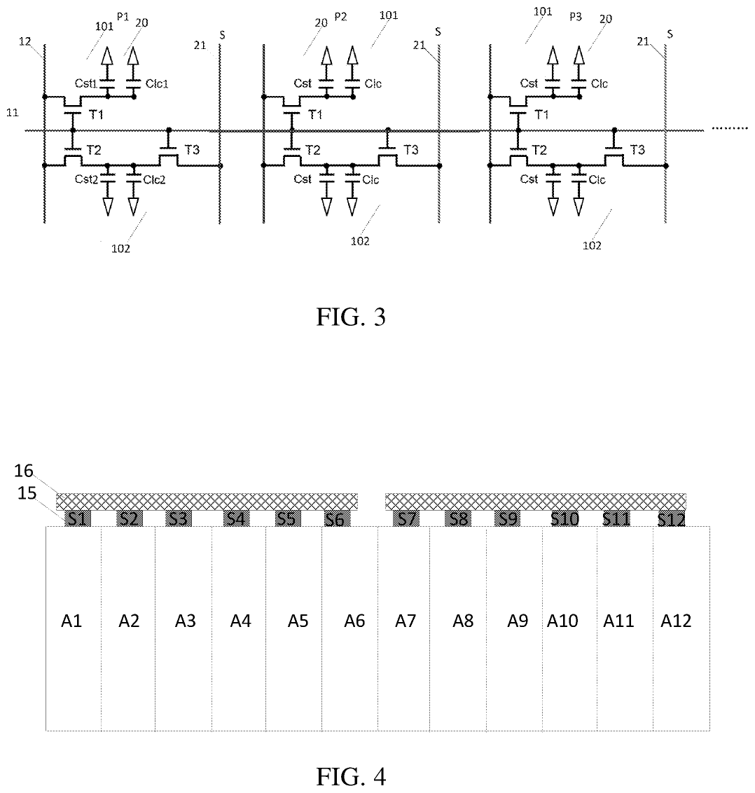

As shown in FIGS. 2 and 3, the LCD panel of the present embodiment comprises a plurality of sub-display regions A1 to An, a plurality of pixels 20 arranged in an array, and a plurality of predetermined electrodes 21.

The pixels 20 are connected to the corresponding scan lines 11 and the corresponding data lines 12. In one embodiment, each row of the pixels 20 is arranged corresponding to one of the scan lines 11, and each column of the pixels 20 is arranged corresponding to one of the data lines 12. The pixels 20 arranged in an array have a plurality of pixel columns P1 to P3, that is, the pixels are arranged in a plurality of columns. Only three columns of the pixels are shown in FIG. 3; however, the present invention is not limited in this regard.

Each of the pixels 20 comprises a main pixel region 101 and a sub-pixel region 102, brightness of the sub-pixel region 102 is lower than brightness of the main pixel region 101. The main pixel region 101 is connected to the corresponding data line 12 and the corresponding scan line 11. Each of the sub-pixel regions 102 is respectively connected to the corresponding data line 12, the corresponding scan line 11, and the predetermined electrode 21 corresponding to the pixel to share electric charges in the sub-pixel region 102. The predetermined electrode 21 corresponding to the pixel is a predetermined electrode corresponding to the sub-display region where the pixel is located.

In one embodiment, as shown in FIG. 3, the main pixel region 101 comprises a first transistor T1. A gate of the first transistor T1 is connected to the corresponding scan line 11, a source of the first transistor T1 of the first transistor T1 is connected to the corresponding data line 12, a drain of the first transistor T1 is connected to a first electrode plate of a first liquid crystal capacitor Clc1 and a first electrode of a first storage capacitor Cst1. The first liquid crystal capacitor Clc1 is formed between the pixel electrode in the main pixel region 101 and a first common electrode, and the first storage capacitor Cst1 is formed between the pixel electrode in the main pixel region 101 and a second common electrode.

The sub-pixel region 102 comprises a second transistor T2 and a third transistor T3. A gate of the second transistor T2 is connected to the corresponding scan line 11, and a source of the second transistor T2 is connected to the corresponding data line 12. A drain of the second transistor T2 is connected to a first electrode plate of a second liquid crystal capacitor Clc2 and a first electrode plate of a second storage capacitor Cst2. The second liquid crystal capacitor Clc2 is formed between the pixel electrode in the sub-pixel region 102 and the first common electrode, and the second storage capacitor Cst2 is formed between the pixel electrode in the sub-pixel region 102 and the second common electrode.

A gate of the third transistor T3 is connected to the corresponding scan line 11, a drain of the third transistor T3 is connected to the corresponding predetermined electrode 21, and a source of the third transistor T3 is connected to the drain of the second transistor T2.

When the third transistor T3 is turned on, part of the voltage in the sub-pixel region 102 enters the predetermined electrode 21, thereby making the brightness of the sub-pixel region 102 darker. Certainly, the pixel is not limited to this particular equivalent circuit structure.

The predetermined electrode 21 is connected to a power supply voltage S. The power supply voltage S can be a direct current (DC) power supply voltage. For example, the power supply voltage ranges from 5V to 10V. In one embodiment, each column of the pixels is arranged corresponding to one predetermined electrode 21. The predetermined electrodes 21 are arranged corresponding to the pixel columns P1 to P3.

Each of the sub-display regions A1 to An comprises at least one pixel column, and the sub-display region is arranged corresponding to at least one predetermined electrode 21. In one embodiment, one of the sub-display regions comprises multiple pixel columns. Taking the sub-display region A1 as an example, it can include two or more pixel columns. The power supply voltages connected to the predetermined electrodes 21 in the same sub-display region are equal. In an example where each pixel column is arranged corresponding to one predetermined electrode, each sub-display region is arranged corresponding to multiple predetermined electrodes. For example, each of the predetermined electrode 21 located in the sub-display region Al is connected to the same power supply voltage. That is, each sub-display region is connected to one power supply voltage, and the power supply voltage in the sub-display region located in a middle of the LCD panel is different from the power supply voltage in the sub-display regions located on two sides of the LCD panel. For example, referring to FIG. 4, the power supply voltages connected to the sub-display regions A1 to A12 are S1 to S12, wherein S12, S11, S10, S9, and S8 are different from S7 and S6, and S1, S2, S3, S4, and S5 are all different from S7 and S6.

In one embodiment, S12, S11, S10, S9, and S8 can all be equal or unequal, and S1, S2, S3, S4, and S5 can all be equal or unequal.

In one embodiment, in order to improve the uniformity of the brightness, the power supply voltages of the sub-display regions are increased from two sides of the LCD panel to the middle, wherein S12<S1<S10<S9<S8<S7; S1<S2<S3<S4<S5<S6, thereby improving viewing angles for rotation angles of liquid crystals vary in a gradient manner. In one embodiment, S7=S6, and certainly, S7 can be unequal to S6.

In one embodiment, in order to improve the uniformity of transmittance, the sub-display regions comprise two middle sub-display regions A6 and A7, and a plurality of first side regions A1 to A5, and a plurality of second side regions A8 to A12. The middle sub-display regions A6 or A7 cover a geometric center of the display region (that is, the geometric center of a rectangle), or the geometric center is disposed in the middle sub-display regions A6 and A7. The first side regions are arranged on a first side with respect to the middle sub-display regions, and the second side regions are arranged on a second side with respect to the middle sub-display regions. In one embodiment, the first side is a left side and the second side is a right side. The number of middle sub-display regions is not limited by this embodiment. The number of the first side regions can be one or more, and the number of the second side regions can also be one or more.

The first side region and the second side region equidistant (with a same distance) from the middle sub-display region are of the same power supply voltage. In one embodiment, when the number of middle sub-display regions is an even number, the distance is a minimum distance. A12 and A1 have the same distance from the middle sub-display region; this applies to the rest side regions, where S12=S1, S11=S2, S19=S3, S9=S4, S8=S5, and S7=S6.

In one embodiment, in order to further improve the uniformity of the transmittance, the power supply voltages of the first side region and the second side region which are equidistant from the middle sub-display region are arranged symmetrically with respect to the middle sub-display region. That is, the number of the first side regions is equal to the number of the second side regions. An area of the first side region is equal to an area of the second side region, so that the brightness from the left and right sides is symmetrical.

In one embodiment, in order to further improve the uniformity of the transmittance, a difference between the power supply voltages of two adjacent sub-display regions is less than or equal to 0.1.

In one embodiment, in order to further improve the uniformity of the transmittance, each of the sub-display regions A1 to A12 has a same area. In other embodiments, the areas of the sub-display regions can be not equal or partially equal.

In other embodiments, as shown in FIG. 2, the display panel comprises n sub-display regions A1 to An. One sub-display region is arranged corresponding to one pixel column, or one sub-display region comprises one pixel column. That is to say, each of the predetermined electrode is arranged corresponding to one pixel column, and one sub-display region is arranged corresponding to one predetermined electrode. A voltage of the k-th predetermined electrode is equal to a voltage of the (n+1-k)-th predetermined electrode. In other words, the number of the sub-display regions is a same as the number of the pixel columns, wherein k is a natural number, and n is greater than or equal to 3. For example, the display panel comprises n pixel columns, the number of the sub-pixel regions is also n. In one embodiment, a difference between the power supply voltages of two adjacent sub-display regions is less than or equal to 0.05, preferably less than 0.01, which means that the difference between the power supply voltages of two adjacent sub-display regions is further reduced, so the panel has smooth brightness transition, thus greatly improving viewing angles. However, the structure also increases the number of flexible connectors and accordingly increases production costs. It is suitable for large-size panels that demands high display performance. Certainly, in other embodiments, multiple pixel columns in each sub-display region can be arranged corresponding to one predetermined electrode.

Each of the sub-display regions Al to An can be connected to the circuit board 16 through a flexible connector 15. The number of the circuit boards 16 can be one, or two, or other numbers.

It should be noted that, FIGS. 2 to 4 are only one example, and are not intended to limit the present invention.

The present invention further provides a display module comprising any one of the above-mentioned LCD panels. The display module can further include a touch screen.

The present invention further provides an electronic device comprising the above-mentioned display module. The electronic device can be a mobile phone, a tablet computer, a computer, and other devices.

Because the display region is divided into multiple sub-display regions, and the predetermined electrodes in the same sub-display region are connected to the same power supply voltage. The power supply voltage in the sub-display region located in the middle of the LCD panel is different from the power supply voltages in the sub-display regions located on two sides of the LCD panel, so that rotation angles of the liquid crystals are unequal, and viewing angles are effectively improved.

The present invention provides the liquid crystal display panel, the display module, and the electronic device. Since the power supply voltage in the sub-display region located in the middle of the LCD panel is different from the power supply voltages in the sub-display regions on both sides of the LCD panel, so that rotation angles of the liquid crystals are unequal, and viewing angles are effectively improved.

In summary, although the present invention has been disclosed above with preferable embodiments. The above preferable embodiments are not intended to limit the present invention. Various changes, substitutions, and alterations can be made without departing from the spirit and scope of the present invention. Therefore, the protection scope of the present invention should be defined by the appended claims.

1. A liquid crystal display (LCD) panel, comprising a display region, the LCD panel comprising:
a plurality of pixels arranged in an array, wherein the pixels are arranged in a plurality of rows of the array, each of the pixels comprises a main pixel region and a sub-pixel region, a brightness of the sub-pixel region is less than a brightness of the main pixel region, and the main pixel region is connected to a corresponding data line and a corresponding scan line;
a plurality of predetermined electrodes, wherein each of the predetermined electrodes receives a power supply voltage, and the sub-pixel region is connected to the corresponding data line, the corresponding scan line, and one of the predetermined electrodes corresponding to each of the pixels to share electric charges in the sub-pixel region; and
a plurality of sub-display regions, wherein each of the sub-display regions comprises at least one row of the pixels arranged corresponding to at least one of the predetermined electrodes, and each of the sub-display regions receives the power supply voltage through the at least one of the predetermined electrodes,
wherein the sub-display regions comprise at least one middle sub-display region, at least one first side region, and at least one second side region, the middle sub-display region covers a geometric center of the display region, the first side region is disposed on a first side with respect to the middle sub-display region, and the second side region is disposed on a second side with respect to the middle sub-display region; the first side region and the second side region are equidistant from the middle sub-display region and are of the same power supply voltage, and the power supply voltages of the sub-display regions increase from the first side region and the second side region to a middle of the LCD panel.

2. (canceled)

3. (canceled)

4. The LCD panel according to claim 1, wherein the first side region and the second side region which are equidistant from the middle sub-display region are arranged symmetrically with respect to the middle sub-display region.

5. The LCD panel according to claim 1, wherein a difference between the power supply voltages of two adjacent sub-display regions is less than or equal to 0.1 volt.

6. The LCD panel according to claim 1, wherein each of the sub-display regions has a same area.

7. The LCD panel according to claim 1, wherein each of the sub-display regions comprises one row of the pixels, and the sub-display regions are disposed corresponding to the predetermined electrodes, respectively.

8. The LCD panel according to claim 1, wherein the main pixel region comprises a first transistor, a gate of the first transistor is connected to the corresponding scan line, a source of the first transistor is connected to the corresponding data line, and a drain of the first transistor is connected to a first electrode plate of a first liquid crystal capacitor and a first electrode plate of a first storage capacitor; the sub-pixel region comprises a second transistor and a third transistor, a gate of the second transistor is connected to the corresponding scan line, a source of the second transistor is connected to the corresponding data line, and a drain of the second transistor is connected to a first electrode plate of a second liquid crystal capacitor and a first electrode plate of a second storage capacitor; and
a gate of the third transistor is connected to the corresponding scan line, a drain of the third transistor is connected to a corresponding one of the predetermined electrodes, and a source of the third transistor is connected to the drain of the second transistor.

9. A display module, comprising a liquid crystal display (LCD) panel, the LCD panel comprising a display region, the display module comprising:
a plurality of pixels arranged in an array, wherein the pixels are arranged in a plurality of rows of the array, each of the pixels comprises a main pixel region and a sub-pixel region, a brightness of the sub-pixel region is less than a brightness of the main pixel region, and the main pixel region is connected to a data line and a scan line;
a plurality of predetermined electrodes, wherein each of the predetermined electrodes receives a power supply voltage, and the sub-pixel region is connected to the corresponding data line, the corresponding scan line, and the predetermined electrodes corresponding to each of the pixels to share electric charges in the sub-pixel region; and
a plurality of sub-display regions, wherein each of the sub-display regions comprises at least one row of the pixels arranged corresponding to at least one of the predetermined electrodes, and each of the sub-display regions receives the power supply voltage through the at least one of the predetermined electrodes,
wherein the sub-display regions comprise at least one middle sub-display region, at least one first side region, and at least one second side region, the middle sub-display region covers a geometric center of the display region, the first side region is disposed on a first side with respect to the middle sub-display region, and the second side region is disposed on a second side with respect to the middle sub-display region; the first side region and the second side region are equidistant from the middle sub-display region and are of the same power supply voltage, and the power supply voltages of the sub-display regions increase from the first side region and the second side region to a middle of the LCD panel.

10. (canceled)

11. (canceled)

12. The display module according to claim 9, wherein the power supply voltages of the first side region and the second side region which are equidistant from the middle sub-display region are arranged symmetrically with respect to the middle sub-display region.

13. The display module according to claim 9, wherein the sub-display regions comprise two middle sub-display regions, and the power supply voltages of the two middle sub-display regions are equal.

14. The display module according to claim 9, wherein a difference between the power supply voltages of two adjacent sub-display regions is less than or equal to 0.1 volt.

15. The display module according to claim 9, wherein each of the sub-display regions has a same area.

16. The display module according to claim 9, wherein each of the sub-display region comprises one row of the pixels, and the sub-display regions are disposed corresponding to the predetermined electrodes, respectively.

17. The display module according to claim 16, wherein a difference between the power supply voltages of two adjacent sub-display regions is less than or equal to 0.05 volt.

18. The display module according to claim 9, wherein the main pixel region comprises a first transistor, a gate of the first transistor is connected to the corresponding scan line, a source of the first transistor is connected to the corresponding data line, and a drain of the first transistor is connected to a first electrode plate of a first liquid crystal capacitor and a first electrode plate of a first storage capacitor; the sub-pixel region comprises a second transistor and a third transistor, a gate of the second transistor is connected to the corresponding scan line, a source of the second transistor is connected to the corresponding data line, and a drain of the second transistor is connected to a first electrode plate of a second liquid crystal capacitor and a first electrode plate of a second storage capacitor; and
a gate of the third transistor is connected to the corresponding scan line, a drain of the third transistor is connected to a corresponding one of the predetermined electrodes, and a source of the third transistor is connected to the drain of the second transistor.

19. (canceled)

20. An electronic device, comprising the display module of claim 9.

21. The LCD panel according to claim 1, wherein the first side region and the second side region are equidistant from the middle sub-display region in a direction in which the sub-display regions are arranged.
